(19) United States
(12) Patent Application Publication
(10) Pub. No.: US 2013/0077154 A1
(43) Pub. Date: Mar. 28, 2013

(54) Autostereoscopic display

(71) Applicants: Milan Momcilo Popovich, Leicester (GB); Jonathan David Waldern, Los Altos Hills, CA (US)

(72) Inventors: Milan Momcilo Popovich, Leicester (GB); Jonathan David Waldern, Los Altos Hills, CA (US)

(21) Appl. No.: 13/200,385

(22) Filed: Sep. 23, 2011

(51) Int. Cl. G02F 1/29; G02B 27/22

(52) U.S. Cl. 359/316

(57) ABSTRACT

An autostereoscopic display is provided comprising a Spatial Light Modulator (SLM), an illuminator, and first and second light redirecting grids. The light directing grids comprise vertical bar-shaped electrically switchable diffractive elements. The light redirecting grids direct light from the illuminator through the SLM towards left and right eye positions.

### REFERENCE TO EARLIER APPLICATION

This application claims the priority of the U.S. Provisional Patent Application No. 61/202,667 filed on 25 Mar. 2009.

### BACKGROUND OF THE INVENTION

This invention relates to autostereoscopic displays, and more particularly to an autostereoscopic display device that uses switchable holographic optical elements.

Conventional stereoscopic displays provide two slightly different perspective images of the same scene. When the display is viewed using a specifically designed colored filter, or polarizing filters, the displayed scene will appear to be three-dimensional. Autostereoscopic displays achieve the same effect without any special viewing aids.

An autostereoscopic display is typically comprised of an input image generator and a screen capable of producing viewer zones at a comfortable distance from the screen. The viewing zones are configured such that each eye of a viewer sees one of a stereo pair of slightly different perspective images, so that the scene displayed on the screen is viewed in a stereoscopic form.

Methods traditionally used to provide autostereoscopic displays have relied on parallax barriers or lenticular lenses. Parallax barriers are essentially grids formed from vertical parallel bars. The two images for the left eye and the right eye are sent to different columns of pixels in a two-dimensional pixel matrix. For example, the left eye image elements may be sent to the odd numbered columns and the right eye image elements may be sent to the even numbered columns. As long as the correct viewing geometry is maintained, the viewer can look through the grid with each eye seeing the correct left or right image. For example, the grid may be inserted between a light source and a transmission Liquid Crystal Display (LCD) such that the grid elements illuminate even or odd columns of pixels depending on which view is being presented. Parallax barriers have significant limitations. For example, if the viewer is incorrectly positioned, the right eye of the viewer can see the image intended for the left eye and vice versa. A further problem is that increasing the number of viewpoints requires grids with wider apertures and opaque bands resulting in a more conspicuous grid and a severely reduced light transmission. One approach to alleviating such limitations is to use lenticular screens, which comprise bands of cylindrical lenses with the images behind each lenticular element consisting of vertical pixel columns. This arrangement allows rays to be directed to predetermined regions of the viewing area. Lenticular screens also have the attribute of being able to provide multiple viewing zones. In practice, however, the image quality will deteriorate as the viewing positions move off axis. The interfacing of lenticular (and parallax) screens to images, in particular images displayed on active matrix displays presents severe registration problems, such as moiré patterns. The autostereoscopic methods described above require a composite input image comprising alternate image stripes for the left and right eyes. One way of increasing the effective viewing field is to create multiple simultaneous views. However, this imposes severe bandwidth requirements. An alternative approach is to track the position of the head and use an image steering system such only two views need to be displayed simultaneously for a given viewer. However, such approaches are expensive and cumbersome.

There is a requirement for an autostereoscopic display that can solve the problems of providing high quality imagery at one or more viewing zones.

### SUMMARY OF THE INVENTION

It is an object of the present invention to provide an autostereoscopic display that can solve the problems of providing high quality imagery at one or more viewing zones.

The objects of the invention are achieved in a first embodiment comprising a Spatial Light Modulator (SLM), an illuminator, a first light redirecting grids and a second light redirecting grid. The light redirecting grids are vertical bar-shaped electrically switchable diffractive elements of identical geometry positioned between the SLM and the viewer. Advantagesously, the bars are SBGs, which can be switched between an active state in which light is diffracted in a specified direction and a passive state in which the incident light is transmitted without deviation and with minor loss. The first light redirecting grid directs light through the SLM towards a left eye position, each bar directing light through a nearby pixel column in the SLM. The second light redirecting grid operates in a similar fashion but now each bar directs light through nearby pixel column at a different angle such that said light is received at the right eye position. By switching the two light redirecting grids at a sufficiently high enough speed a stereoscopic image is formed at one fixed viewing position. In one operational configuration the light redirecting grid bars exactly overlap the columns of pixels of the SLM. In another operational embodiment each column of SLM pixels covers one bar from each of the first and second light redirecting grids.

In a second embodiment of the invention the first and second light redirecting grids are configured to diffuse light over a range of angles, such that the resulting displays provide multiple view points, each having identical left eye and right eye perspective views.

In third embodiment of the invention multiple pairs of light redirecting grids are configured to provide different left and right eye perspective views at more than one viewing position, such that the display may present different perspective views to multiple viewers. Alternatively, the same embodiment of the invention may be augmented with a head tracker to present different perspective views to a single viewer.

In a fourth embodiment of the invention a full color autostereoscopic display is provided by means of a first stack of red, green and blue light redirecting grids operative to direct light to a the left eye viewpoint and second stack of red, green and blue light redirecting grids operative to direct light to a right eye viewpoint.

In a fifth embodiment of the invention, similar to the fourth embodiment, a full color autostereoscopic display is provided by using red, green and blue diffracting light redirecting grids grouped in red, green and blue pairs.

In a sixth embodiment of the invention, a color autostereoscopic display is provided wherein red, green and blue illumination is provided sequentially at three different incidence angles. The display is comprised of an SLM, an illuminator and first and second light redirecting grids.

In a seventh embodiment of the invention first and second light directing grids are combined in a single layer as interleaved grids. In a first operational configuration the display is comprised of an SLM, an illuminator and a light redirecting element. The light directing grid bars exactly overlap the columns of pixels of the SLM. In another operational embodiment each column of SLM pixels covers one bar from each of the first and second light redirecting grids. The first and second light redirecting grids may be activated sequentially or simultaneously. In the mode where they are activated sequentially, the SLM displays only the information for the left view point when the first light redirecting grid is activated and the second light redirecting grid is deactivated. Likewise, the SLM displays only the information for the right eye viewpoint when the second light redirecting grid is activated and the first light redirecting grid is deactivated. In the mode where the first and second light redirecting grids are activated simultaneously the SLM displays left and right eye point information in alternating columns. The light redirecting grids may be provided with diffusing properties to create multiple viewing positions. Further light redirecting grids may be added to provide multiple viewing positions with different left and right eye perspective views.

In an eighth embodiment of the invention, related to the seventh embodiment, the first and second light directing grids are combined in a single layer as interleaved grids and red, green and blue illumination is provided sequentially at three different angles.

In a ninth embodiment of the invention, related to the seventh embodiment, a color autostereoscopic display is provided wherein three layers each comprising first and second light redirecting grids combined in a single layer as interleaved grids are provided. Each layer diffracts one of red, green or blue light towards the left and right eye viewpoints.

In a tenth embodiment of the invention, a color autostereoscopic display is provided in which the first and second light redirecting grids and the SLM are combined in a single layer pixelated array. The first and second light redirecting grids may be activated sequentially or simultaneously. In the mode where they are activated sequentially the SLM displays only the information for the left view point when the first light redirecting grid is activated and the second light redirecting grid is deactivated. Likewise, the SLM displays only the information for the right eye viewpoint when the second light redirecting grid is activated and the first light redirecting grid is deactivated. In the mode where the first and second light redirecting grids are activated simultaneously the SLM displays left and right eye point information in alternating columns. The light redirecting grids may be provided with diffusing properties to create multiple viewing positions. Further light redirecting grids may be added to provide multiple viewing positions with different left and right eye perspective views.

In an eleventh embodiment of the invention a color autostereoscopic display is provided in which the first and second light redirecting grids are each provided by groups of red, green and blue pixelated SBG arrays, wherein each said array also performs the function of an SLM. In an alternative embodiment the pixelated arrays may be grouped in red green and blue pairs.

In yet further embodiments of then invention based on said the first to ninth embodiments the light redirecting grids may be replaced by two dimensional arrays of electrically switchable diffractive elements.

A more complete understanding of the invention can be obtained by considering the following detailed description in conjunction with the accompanying drawings wherein like index numerals indicate like parts. For purposes of clarity details relating to technical material that is known in the technical fields related to the invention have not been described in detail.

### BRIEF DESCRIPTION OF THE DRAWINGS

FIG. 1 is a three dimensional schematic view of an autostereoscopic display.

FIG. 2a is a schematic top view of an autostereoscopic display showing a first operational configuration of the spatial light modulator.

FIG. 2b is a schematic top view of an autostereoscopic display showing a second operational configuration of the spatial light modulator.

FIG. 3 is a schematic top view of an autostereoscopic display with a single viewing position.

FIG. 4 is a schematic top view of an autostereoscopic display that provides multiple viewing positions with identical perspective views.

FIG. 5 is a schematic top view of an autostereoscopic display that provides multiple viewing positions with different perspective views.

FIG. 6 is a schematic top view of a first operational embodiment of an autostereoscopic display configured to provide color images at one viewing position.

FIG. 7 is a schematic top view of a second operational embodiment of an autostereoscopic display configured to provide color images at one viewing position.

FIG. 8 is a schematic top view of a color autostereoscopic display wherein red, green and blue illumination is provided at three different angles to first and second light redirecting grids.

FIG. 9A is a schematic top view of an autostereoscopic display in which the first and second light redirecting grids comprising interleaved arrays with element widths equal to the SLM column width.

FIG. 9B is a schematic top view of an autostereoscopic display similar to that shown in FIG. 9A in which the left and right light redirecting optics comprise interleaved arrays having element widths smaller than the SLM column width.

FIG. 10 is a schematic top view of a color autostereoscopic display in which the first and second light directing grids are combined in a single layer as interleaved grids and red, green and blue illumination is provided sequentially at three different angles.

FIG. 11 is a schematic top view of a color autostereoscopic display in which the first and second light redirecting grids comprise interleaved grids in a single layer with separate layers being provided for red green and blue components of the image.

FIG. 12 is a schematic top view of a color autostereoscopic display in which the first and second light redirecting grids and the SLM are combined in a single layer

FIG. 13 is a schematic top view of a color autostereoscopic display wherein the left and right eye redirecting optics are each provided by groups of red, green and blue pixelated arrays and wherein each array also performs the function of an SLM.

FIG. 14 is a schematic top view of a color autostereoscopic display similar in concept to that illustrated in FIG. 13, wherein the SBG arrays are grouped in red green and blue pairs wherein each array also performs the function of an SLM.

FIG. 15 is a three dimensional schematic view of an autostereoscopic display.

### DETAILED DESCRIPTION OF THE INVENTION

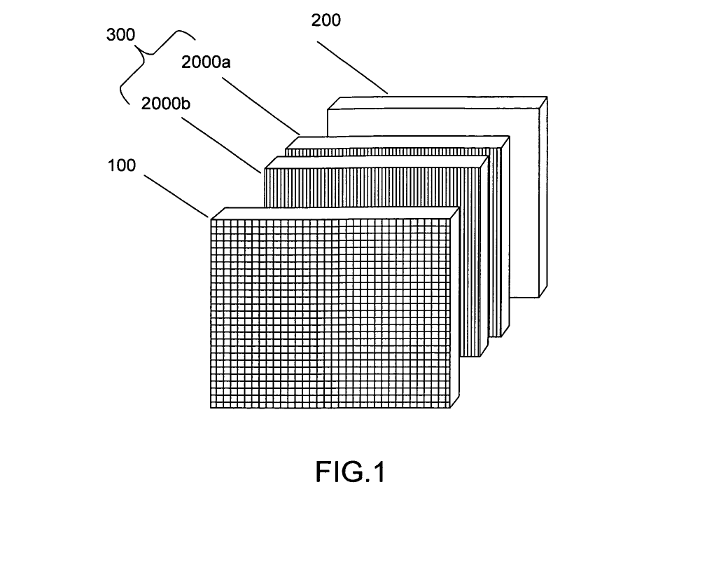

As shown in FIG. 1 the functional elements of an autostereoscopic display according to the basic principles of the invention comprise of a Spatial Light Modulator (SLM) 100, a light source 200 and a light redirecting device 300. The function of the light redirecting device is to deflect light from the source 200 through the modulator towards the left and right eye positions. The light redirecting elements comprises a first light redirecting grid 2000a and a second light redirecting grid 2000b. Each said light redirecting means comprises a plurality of elongate parallel electrically switchable diffractive elements extending in a vertical direction and, when viewed in plan view, being operative to deflect light within a horizontal plane containing the left and right eye points. The switchable light redirecting means are in optical contact with the SLM. Desirably, the first and second light redirecting elements have identical spatial frequencies.

Advantageously, the light redirecting grids employ Switchable Bragg Gratings (SBG) technology. Switchable Bragg Gratings (SBGs) are well-known optical components formed by recording a volume phase grating, or hologram, in a polymer dispersed liquid crystal (PDLC) mixture. Typically, HPDLC devices are fabricated by first placing a thin film of a mixture of photopolymerisable monomers and liquid crystal material between parallel glass plates. One or both glass plates support electrodes, typically transparent indium tin oxide films, for applying an electric field across the PDLC layer. A volume phase grating is then recorded by illuminating the liquid material with two mutually coherent laser beams, which interfere to form the desired grating structure. During the recording process, the monomers polymerize and the PDLC mixture undergoes a phase separation, creating regions densely populated by liquid crystal micro-droplets, interspersed with regions of clear polymer. The alternating liquid crystal-rich and liquid crystal-depleted regions form the fringe planes of the grating. The resulting volume phase grating can exhibit very high diffraction efficiency, which may be controlled by the magnitude of the electric field applied across the PDLC layer. When an electric field is applied to the hologram via transparent electrodes, the natural orientation of the LC droplets is changed causing the refractive index modulation of the fringes to reduce and the hologram diffraction efficiency to drop to very low levels. Note that the diffraction efficiency of the device can be adjusted, by means of the applied voltage, over a continuous range near 100% efficiency with no voltage applied to essentially zero efficiency with a sufficiently high voltage applied. For the purposes of explaining the invention the SBG is defined as being in its ON state in the absence of an applied electric field and in its OFF state when an electric field is applied.

U.S. Pat. No. 5,942,157 by Sutherland et al. and U.S. Pat. No. 5,751,452 by Tanaka et al. describe monomer and liquid crystal material combinations suitable for fabricating HPDLC devices. A recent publication by Butler et al. (“Diffractive properties of highly birefringent volume gratings: investigation”, Journal of the Optical Society of America B, Volume 19 No. 2, February 2002) describes analytical methods useful to design HPDLC devices and provides numerous references to prior publications describing the fabrication and application of HPDLC devices.

The light source may comprise a single light source with collimating optics or alternatively may rely on an edge illuminated light guide of the type commonly used in edge lit holograms. The light source may be monochromatic or, alternatively, may be configured to provide color sequential illumination, ie red green and blue light in sequence. The light source may be a broad band white light source such as an arc lamp or a tungsten halogen lamp. The light source may comprises red, green and blue Light Emitting Diodes (LEDs) or lasers. The spatial light modulator may be a Liquid Crystal Display (LCD) or an array based on HPDLC material. Although separate spaced elements are shown in FIG. 1, the SLM, light source and SBG layers may be integrated within a single laminated component to provide a compact flat panel display element.

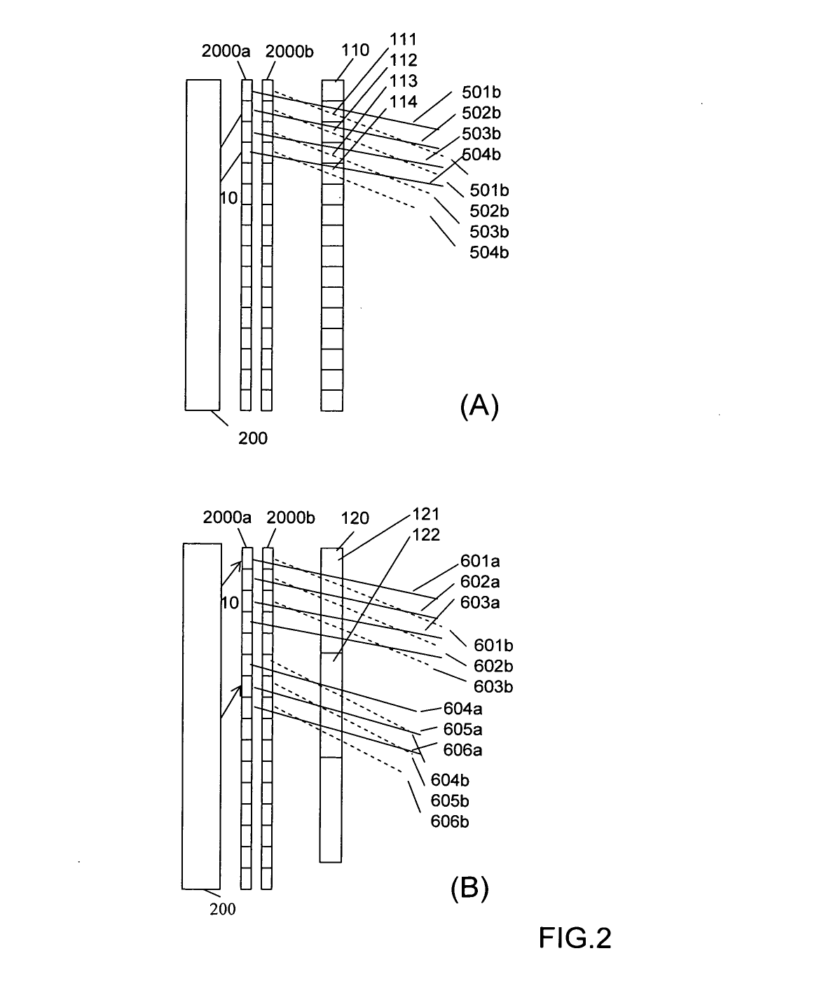

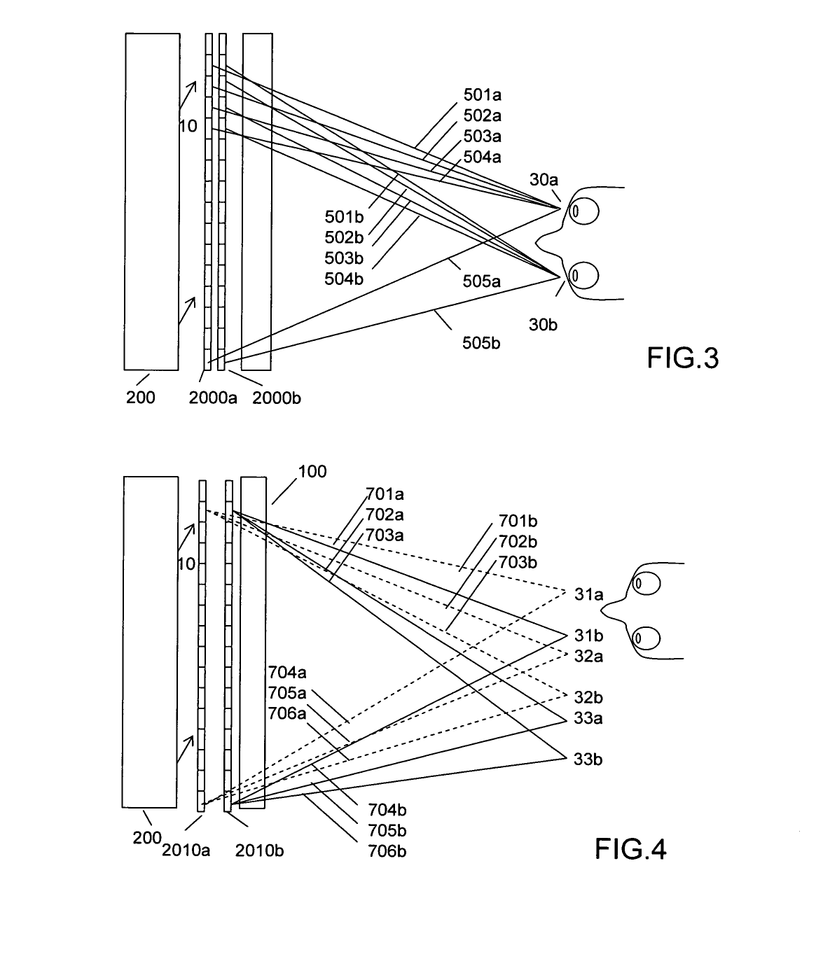

Turning now to the schematic top view of FIGS. 2A-2B and FIG. 3, which contain the same components as FIG. 1, the basic principles of the invention will be explained in more detail. FIGS. 2A-2B and FIG. 3 show a monochromatic autostereoscopic display configured to provide a single viewpoint with left and right eye perspective views being presented at the viewpoints 30a and 30b respectively. The display is comprised of an SLM 100, a light source 200, a first light redirecting grid 2000a and a second light redirecting grid 2000b. The illumination light rays, generally indicated by the numeral 10, are incident on the light redirecting at a large angle to satisfy the well known ray geometrical requirements of diffractive optical elements such as SBGs. In the preferred embodiments of the invention the first and second light redirecting grids comprise arrays of vertical SBG bars. The SBG bars in the first and second light redirecting grids are of identical spatial frequency.

In one operational configuration of the SLM shown in FIG. 2A the SLM pixel width and spatial frequency is identical to the light redirecting grid bar width and spatial frequency and both light redirecting grids are aligned such that each bar exactly overlaps one pixel column. Referring to FIG. 2a, when the light redirecting grid 2000a is ON and the light redirecting grid 2000b is OFF the rays 501b to 504b which are generally indicated by the dashed lines propagate through the SLM pixels towards the left eye point. When the light redirecting grid 2000b is ON and the light redirecting grid 2000b is OFF the rays 501a to 504a which are generally indicated by the solid lines propagate through the SLM pixels towards the right eye point. In this case each SLM pixel column receives rays from a single bar.

In a second operational configuration of the SLM shown in FIG. 2B the SLM pixels have widths corresponding to several light redirecting grid bar widths. In this case the rays passing through a given SLM pixel column would correspond to one viewing direction and would be substantially parallel. When the light redirecting grid 2000a is ON and the light redirecting grid 2000b is OFF the parallel rays 601b to 603b, generally indicated by the solid lines, propagate through a first SLM pixel towards the left eye point, while the parallel rays 604b to 606b propagate through an adjacent SLM pixel towards the left eye point. When the light redirecting grid 2000b is ON and the light redirecting grid 2000a is OFF the parallel rays 601a to 603a, generally indicated by the dashed lines, propagate through a first SLM pixel towards the right eye point, while the parallel rays 604a to 606a propagate through an adjacent SLM pixel in a second direction towards the right eye point. In all other respects the operation of the display is identical to that of the embodiment of FIG. 2A.

FIG. 3 illustrates how the embodiments of either FIG. 2A or FIG. 2B provide left and right eye viewing points. As shown in FIG. 3 the first light redirecting grid 2000a converges rays such as 501b-505b towards the eye point 30a while the second light redirecting grid 2000b converges rays such as 501a-505a towards the eye point 30b. The details of the SLM are not shown in FIG. 3 and the following Figures since either of the two SLM configurations described above in FIGS. 2A to 2B may be used with any of the embodiments of the invention to be described hereafter. It should be noted that for the purposes of describing the invention, eye points are defined as the intersection of the geometrical optical left and right eye viewing zones with horizontal plane orthogonal to the display surface

FIG. 4 illustrates a second embodiment of the invention that provides multiple viewing positions each having identical left and right eye perspective views. As shown in FIG. 4 the display is comprised of an SLM 100, a light source 200 a first light redirecting grid 2010a and a second light redirecting grid 2010b. However, in this embodiment the light redirecting grids are based on have diffusing characteristics such that light from the illuminator is scattered into a range of angles. For example, when light redirecting grid 2010a is in the ON state and light redirecting grid 2010b is in the OFF state, light is scattered along ray directions 701a to 703a and 704a to 706a towards the left eye points 31a to 33a respectively. When light redirecting grid 2010b is in the ON state and 2010a is in the OFF state, light is scattered along ray directions 701b to 703b and 704b to 706b towards the left eye points 31b to 33b respectively. The techniques for incorporating diffusing characteristics within Bragg grating devices are well know to those skilled in the art of holography. One well known method relies on incorporating a diffusing element in the hologram recording apparatus. U.S. Pat. No. 6,191,876 by Popovich discloses methods for providing SBGs with diffusing characteristics suitable for multiple viewpoint autostereoscopic displays.

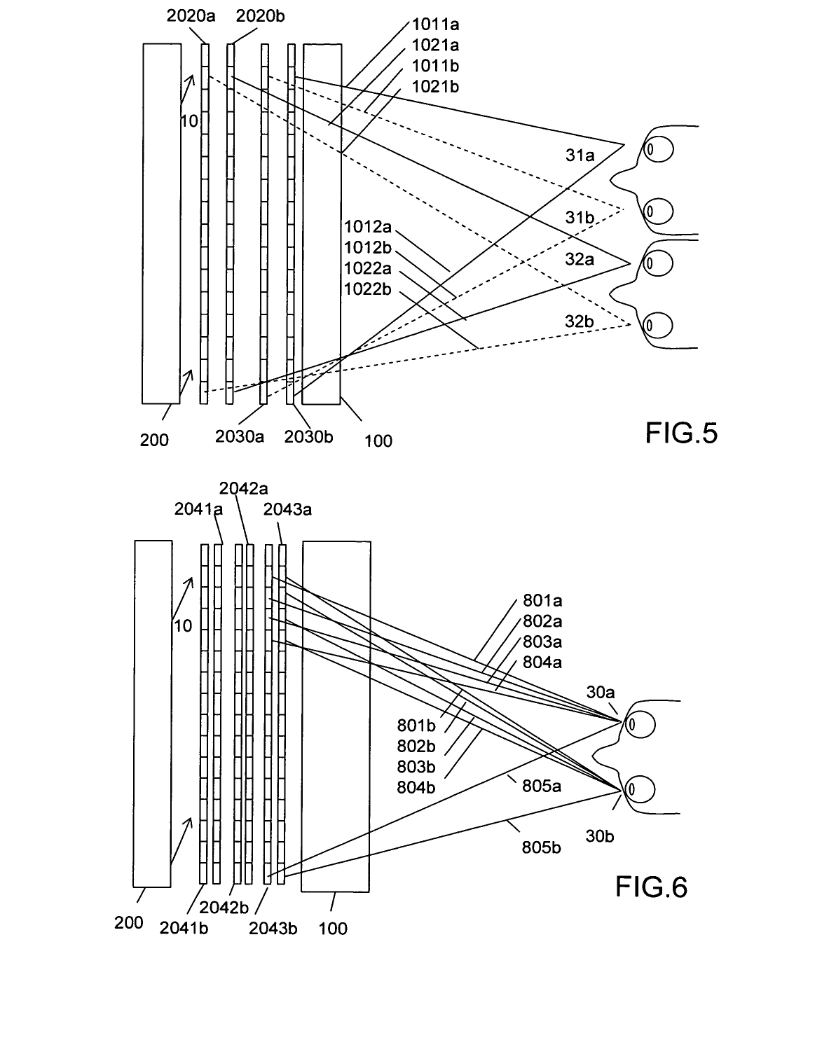

FIG. 5 illustrates a third embodiment of the invention that provides multiple viewing positions with different left and right eye perspective views. As shown in FIG. 5 the display is comprised of an SLM 100, a light source 200 a first pair of light redirecting grids 2020a and 2020b and a second pair of light redirecting grids 2030a and 2030b. The light source provides illumination in the direction generally indicated by 10. The pair of light redirecting grids 2030a and 2030b is configured to direct rays to the eye points 32a and 32b. The pair of light redirecting grids 2020a and 2020b is configured to direct rays to the eye points 31a and 31b. We first consider a first viewing position defined by eye points 31a, 31b. When the light redirecting grids 2030a is ON and the other light redirecting grids are OFF rays such as 1011b and 1012b are directed to the left eye point 31b. When the light redirecting grid 2030b is ON and the other light redirecting grids are OFF rays such as 1011a and 1012a are directed to the right eye point 31a. We next consider the second viewing position defined by the eye points 32a, 32b. When the light redirecting grids 2020a is ON and the other light redirecting grids are OFF rays such as 1021b and 1022b are directed to the left eye point 32b. When the light redirecting grid 2020b is ON and the other light redirecting grids are OFF rays such as 1021a and 1022a are directed to the right eye point 32a.

With respect to the embodiment illustrated in FIG. 5 it should be understand that providing stereoscopic imagery with different perspective views to multiple viewers would require an SLM a fast update rate since the image would need to be updated each time a new light redirecting grid is activated. In a further embodiment of the invention the embodiment of FIG. 5 augmented by a head position track device could be used to provide multiple different perspective views to a single view.

FIG. 6 illustrates an operational aspect of the invention directed at providing full color autostereoscopic imagery at a single viewpoint. As shown in FIG. 6 the display is comprised of a SLM 100, a light source 200 a first pair of light redirecting grids 2041a and 2041b, a second pair of light redirecting grids 2042a and 2042b and a third pair of light redirecting grids 2043a and 2043b. The light source provides illumination in the direction generally indicated by 10. The first, second and third pairs of light redirecting grids are operational to diffract red, green and blue light respectively. For example, referring to FIG. 6, we will consider the formation of the blue component of the image. The light redirecting grids 2043a and 2043b are used to provide the left and right eye perspective views respectively. When light redirecting grid 2043a is in the ON state and light redirecting grid 2043b is in the OFF state, light is directed along ray directions such as 801a to 805a towards the left eye point 30a. When light redirecting grid 2043b is in the ON state and light redirecting grid 2043a is in the OFF state, light is directed along ray directions such as 801b to 805b towards the left eye point 30b.

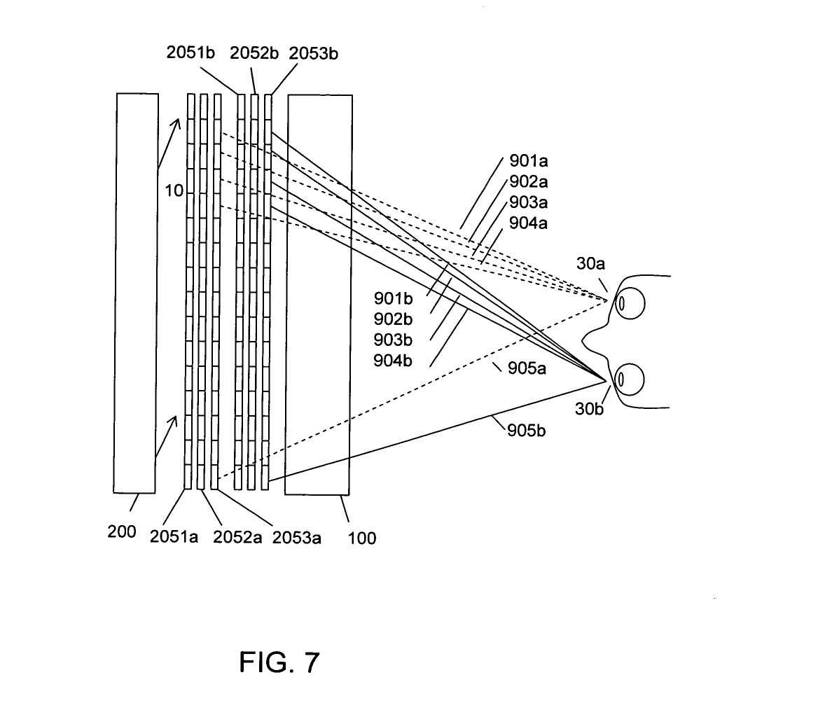

FIG. 7 illustrates a further operational aspect of the invention directed at providing full color autostereoscopic imagery at a single viewpoint. As shown in FIG. 7 the display is comprised of an SLM 100, a light source 200 a first group of three light redirecting grids 2051a, 2052a and 2053a and a second pair of light redirecting grids 2051b, 2052b and 2053b. The light source provides illumination in the direction generally indicated by 10. The first group of light redirecting grids 2051a, 2052a and 2053a is operational to diffract red, green and blue light respectively to the left eye viewpoint 30a. The second group of light redirecting grids 2051b, 2052b and 2053b is operational to diffract red, green and blue light respectively to the right eye viewpoint 30b. For example, in the case of green light, the light redirecting grids 2053a and 2053b are used to provide the right and left eye perspective views respectively. The light redirecting grids 2051a, 2051b, 2052a and 2052b are in the OFF state. Now when light redirecting grid 2053a is in the ON state and light redirecting grid 2053b is in the OFF state, light is directed along ray directions such as 901a to 905a towards the left eye point 30a. When light redirecting grid 2053b is in the ON state and light redirecting grid 2053a is in the OFF state, light is directed along ray directions such as 901b to 905b towards the right eye view point 300b.

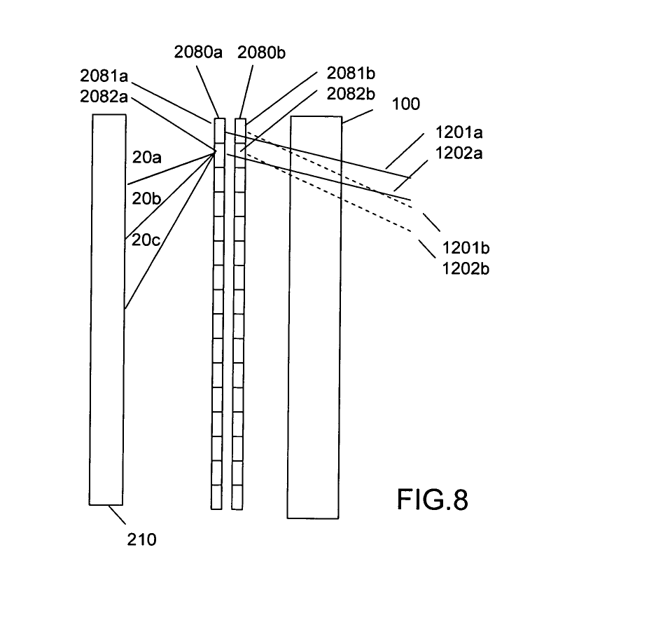

FIG. 8 is a schematic top view of a further embodiment of the invention, which provides a color autostereoscopic display, wherein red, green and blue illumination is provided sequentially at three different incidence angles. The display is comprised of an SLM 100, an illuminator 210 and first and second light redirecting grids 2080a, 2080b. The first light redirecting grid 2080a contains bars such as 2081a, 2082a operational to deflect light in the direction 1201a, 1202a towards the left eye view point. The second light redirecting grid contains bars such as 2081b, 2082b operational to direct light 1201b, 1202b towards the right eye view point. The left and right eye viewpoints are not shown. This embodiment of the invention device relies on the property of Bragg gratings that high diffraction efficiency can be provided for different incidence angle having different wavelengths. The basic principle may be understood from inspection of the Bragg diffraction equation which may be stated as 2nd sin(θ)=λ, where λ is the wavelength, n is the refractive index, d is the Bragg surface separation and θ is the Bragg diffraction angle. Red light at a first incidence angle 20a, green light at a second incidence angle 20b and blue light at a third incidence angle 20c can be diffracted towards the left eye point along directions such as 1201a, 1202a by the first light redirecting element 2080a. Similarly, red light at a first incidence angle 20a, green light at a second incidence angle 20b and blue light at a third incidence angle 20c can be diffracted towards the left eye point along directions such as 1201b, 1202b by the second light redirecting element 2080b.

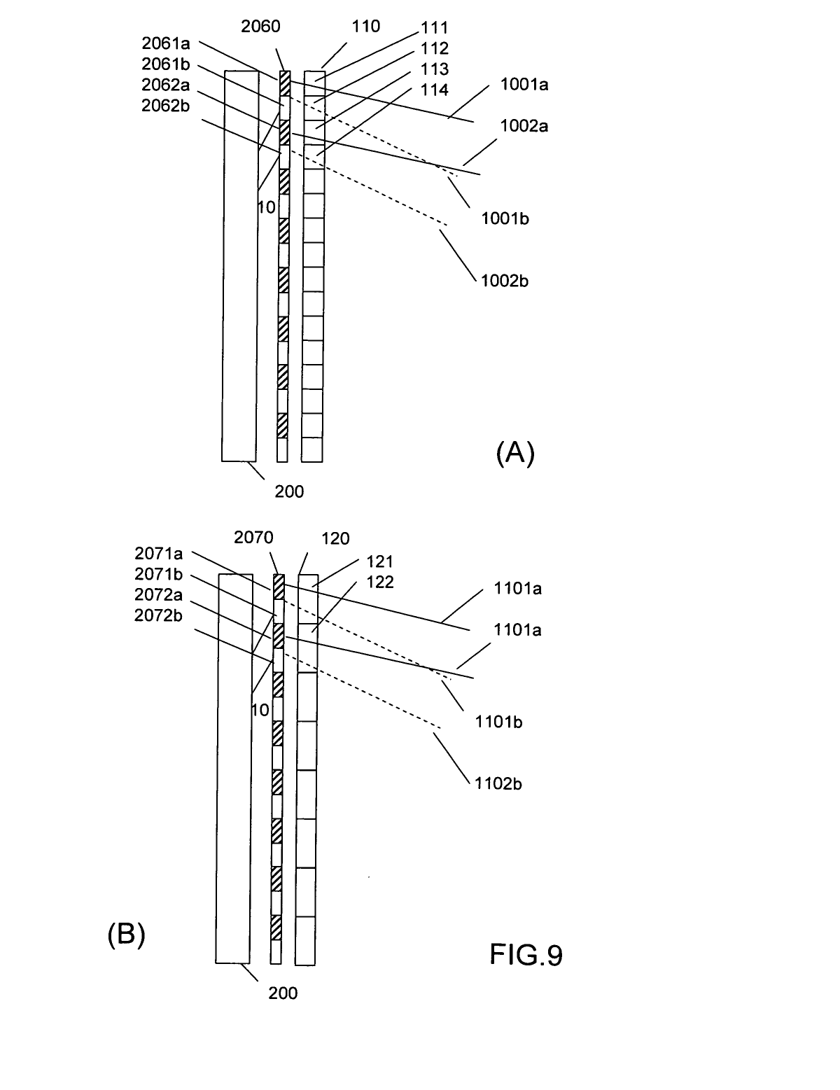

FIG. 9 illustrates a further embodiment of the invention directed at providing stereoscopic imagery at a single viewpoint. In this embodiment the first and second light directing grids are combined in a single layer as interleaved grids. Two operational embodiments are illustrated in the schematic top views of FIG. 9A and FIG. 9B. In a first operational embodiment shown in FIG. 9A, the display is comprised of an SLM 110, an illuminator 200 and a light redirecting element 2060. The SLM is a two dimensional array of which pixel columns 111 to 114 are indicated in FIG. 9A. As shown in FIG. 9A the light directing grid bars exactly overlap the columns of pixels of the SLM. The light redirecting elements contains a first grid of bars such as 2061a, 2062a operational to deflect light in the directions 1001a, 1002a through SLM columns, such as 111, 113, towards the left eye view point and a second grid of bars such as 2061b, 2062b operational to direct light 1001b, 1002b through SLM columns such as 112, 114, towards the right eye view point. The left and right viewpoints are not shown.

FIG. 9B shows an alternative embodiment of the invention similar to that illustrated in FIG. 9A. However, in FIG. 9B the first and second light redirecting grids have higher resolution such that each column of SLM pixels covers one bar from each of the first and second light redirecting grids. The display is comprised of an SLM 120, an illuminator 200 and a light redirecting element 2070. The SLM is a two dimensional array of which pixel columns 111 to 114 are indicated in FIG. 9A. The light redirecting element 2070 contains a first grid of bars such as 2071a, 2072a operational to deflect light in the directions 1101a, 1102a towards the left eye view point and a second grid of bars such as 2071b, 2072b operational to direct light 1101b, 1102b towards the right eye view point. Each column of pixels of the SLM transmits both left and right eye information. For example, pixel column 121 transmits rays 2071a and 2071b towards the left eye point and right eye point respectively, while pixel column 122 transmits rays 2072a and 2072b towards the left eye point and right eye point respectively. The left and right viewpoints are not shown.

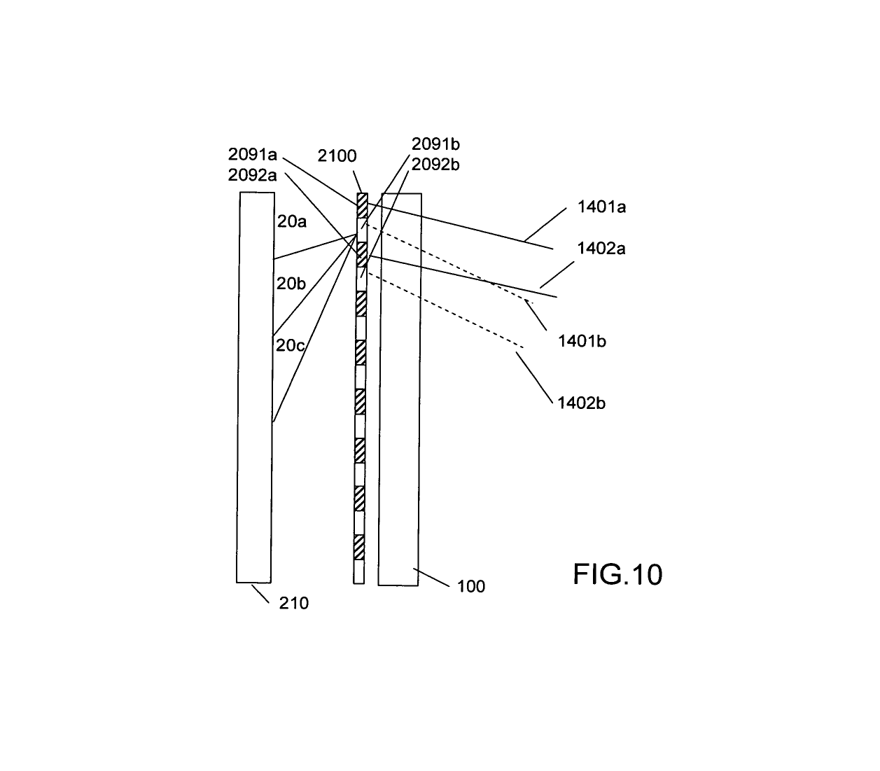

FIG. 10 is a schematic top view of a color autostereoscopic display in which the first and second light directing grids are combined in a single layer as interleaved grids. Red, green and blue illumination is provided sequentially at three different angles. The basic principles of the illumination method have already been explained in relation to the embodiment of FIG. 8. The display is comprised of an SLM 100, an illuminator 210 and a light redirecting element 2100. The light redirecting element 2100 comprises a first grid of bars such as 2091a, 2092a operational to deflect light in the directions 1401a, 1402a towards the left eye view point and a second grid of bars such 2091b, 2092b operational to direct light 1401b, 1402b towards the right eye view point. The left and right viewpoints are not shown. Red light at a first incidence angle 20a, green light at a second incidence angle 20b and blue light at a third incidence angle 20c can be diffracted into the directions 1401a, 1402a by bars 2091a, 2092a of the light redirecting element and into the directions 1401b, 1402b by bars 2091b, 2092b of the light redirecting element. The details of the SLM are not shown in FIG. 3 since either of the two SLM configurations described above in FIGS. 9A to 9B may be used.

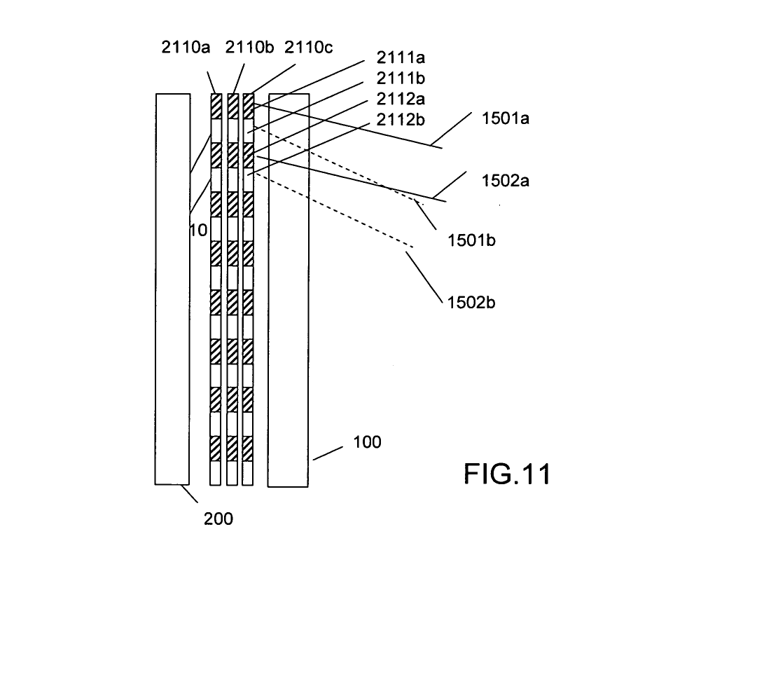

FIG. 11 is a schematic top view of a color autostereoscopic display similar to that illustrated in FIG. 9 in which the first and second light redirecting grids are combined in a single layer as interleaved grids. In the embodiment of FIG. 11 separate layers 2110a, 2110b, 2110c are provided for red green and blue respectively. Said red, green and blue illumination is provided sequentially in a common direction. The display is comprised of an SLM 100, an illuminator 200 and the group of light redirecting grid 2110a, 2110b, 2110c. The light redirecting grids 2110a, 2110b, 2110c are switched sequentially. For example, the elements 2111a and 2112a of blue light redirecting grid 2110c diffract blue light into the directions such as 1501a, 1502a towards a left eye point. Similarly, the elements 2111b and 2112b of blue light redirecting grid 2110c diffract blue light into the directions such as 1501b, 1502b towards a right eye point. The viewpoints are not shown. The details of the SLM are not shown in FIG. 3 since either of the two SLM configurations described above in FIGS. 9A to 9B may be used.

It should be noted that in the embodiments of FIG. 9-11 the first and second light redirecting grids may be activated sequentially or simultaneously. In the mode where they are activated sequentially the SLM displays only the information for the left view point when the first light redirecting grid is activated and the second light redirecting grid is deactivated. Likewise, the SLM displays and only the information for the right eye viewpoint when the second light redirecting grid is activated and the first light redirecting grid is deactivated. In the mode where the first and second light redirecting grids are activated simultaneously, the SLM displays left and right eye point information in alternating columns. Clearly to gain the benefit of higher SLM resolution afforded by the sequential operation of the light redirecting grids it is necessary to use a fast switching SLM device.

It should further be noted that in the embodiments of FIG. 9-11 the said light redirecting grids may be provided with diffusing properties to create multiple viewing positions as shown in the embodiment of FIG. 4.

It should further be noted that in the embodiments of FIG. 9-11 further light redirecting grids may be added to provide multiple viewing positions with different left and right eye perspective views as shown in the embodiment of FIG. 5

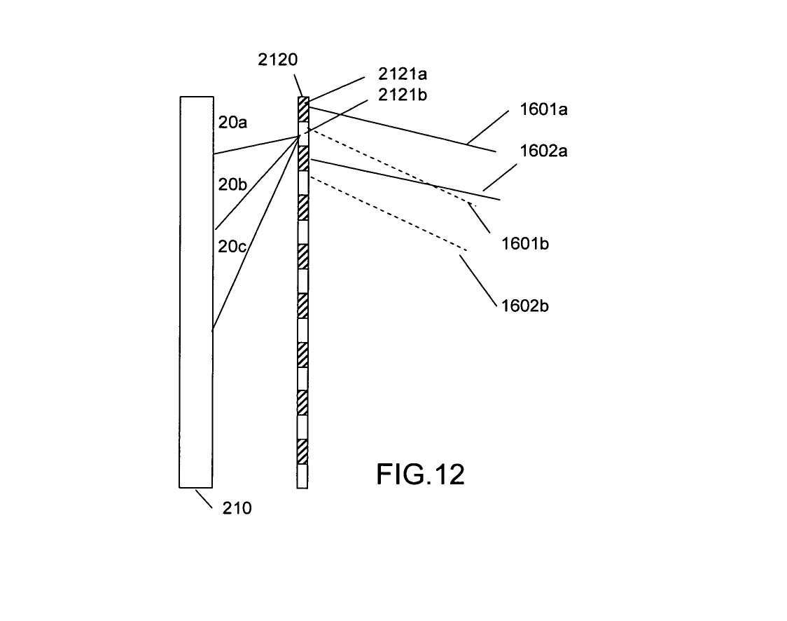

FIG. 12 is a schematic top view of a further embodiment of the invention, which provides a color autostereoscopic display in which the first and second light redirecting grids and the SLM are combined in a single layer pixelated array. The display is comprised of an illuminator 210 and the pixelated array 2120. Advantageously, the array is based on SBG technology. The first and second light redirecting grids are provided by alternate columns of pixels of the array. The pixels of the odd columns of the array contain gratings configured to diffract light towards the left eye viewpoint while the pixels of the even columns of the array contain gratings configured to diffract light towards the right eye viewpoint. Red, green and blue illumination is provided sequentially at three different angles 20a, 20b, 20c respectively by the illuminator 210 and is diffracted according to the basic principles already discussed in relation to the embodiment of FIG. 8 The odd columns of the array provide a first grid of bars such as 2121a operational to deflect light in the directions 1601a, 1602a towards the left eye view point and a second grid of bars such 2121b operational to direct light in the directions 1601b, 1602b towards the right eye view point. The left and right viewpoints are not shown.

It should be noted that in the embodiment of FIG. 12 the first and second light redirecting grids may be activated sequentially or simultaneously. In the mode where they are activated sequentially the pixelated array of FIG. 12 displays only the information for the left view point when the first light redirecting grid is active and only the information for the right eye viewpoint when the second light redirecting grid is active. On the other hand if the first and second light redirecting grids are activated simultaneously, the pixelated array displays left and right eye point information in alternating columns. Clearly to gain the benefit of higher resolution afforded by the sequential operation of the light redirecting grids it is necessary to use a fast switching pixelated array.

It should further be noted that in the embodiments of FIG. 12 the said light redirecting grids may be provided with diffusing properties to create multiple viewing positions as shown in the embodiment of FIG. 4.

It should further be noted that in the embodiments of FIG. 12 further pixelated arrays may be added to provide multiple viewing positions with different left and right eye perspective views according to the basic principles of the embodiment of FIG. 5.

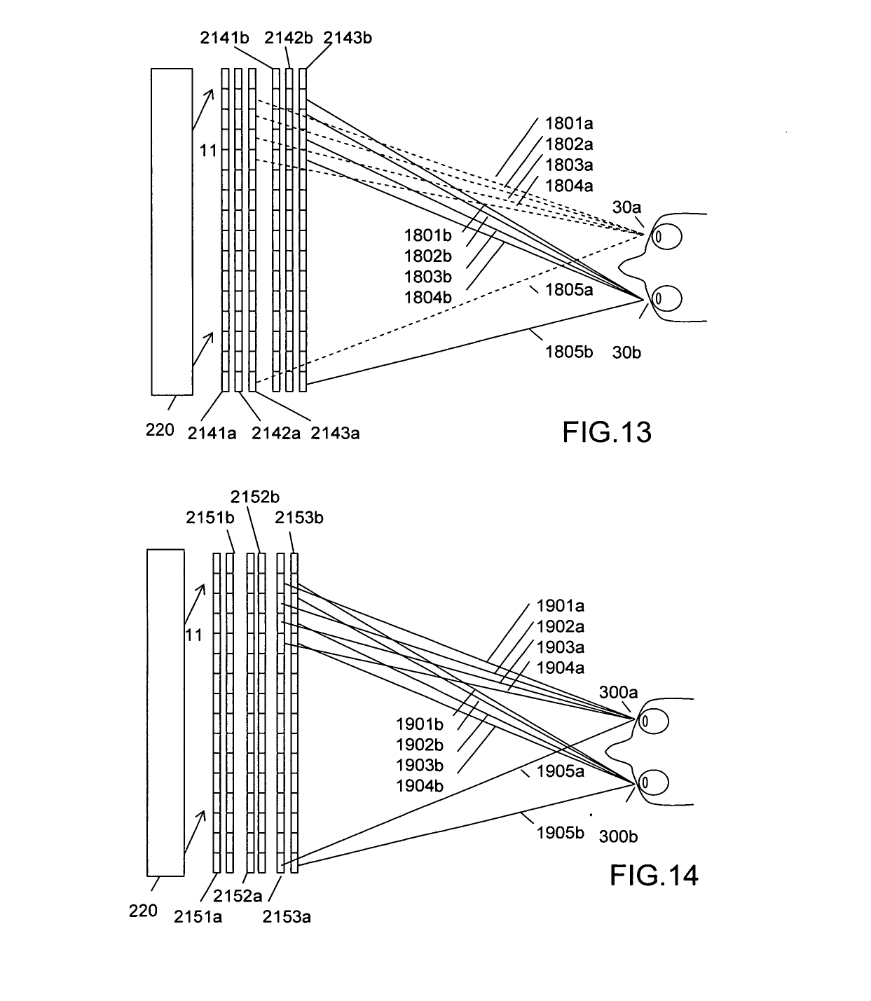

FIG. 13 is a schematic top view of a color autostereoscopic display in which the left and right eye redirecting optics are each provided by groups of red, green and blue pixelated arrays, wherein each said array also performs the function of an SLM. Advantageously, the arrays are based on SBG technology. The display comprises an illuminator 220, which provides red, green and blue illumination generally indicated by 11 a first group of red, green and blue arrays 2141a, 2142a, 2143a and a second group of red, green and blue arrays 2141b, 2142b, 2143b. In the first group of red, green and blue arrays 2141a, 2142a, 2143a each said array provides a light redirecting grid operative to deflect red, green and blue rays towards the right eye point 30b. In the second group of red, green and blue arrays 2141b, 2142b, 2143b each said array provides a light redirecting grid operative to deflect red, green and blue rays towards the left eye point 30a. In each case the light grid is provided by the columns of pixels of the array. FIG. 13 illustrates the propagation of blue light. In this case rays 1801a-1805a are diffracted into the direction of the left eye viewpoint 30a by the columns of pixels of array 2143a. At the same time rays 1801b-1805b are diffracted in to the direction of the right eye viewpoint by the columns of pixels of arrays 2143b.

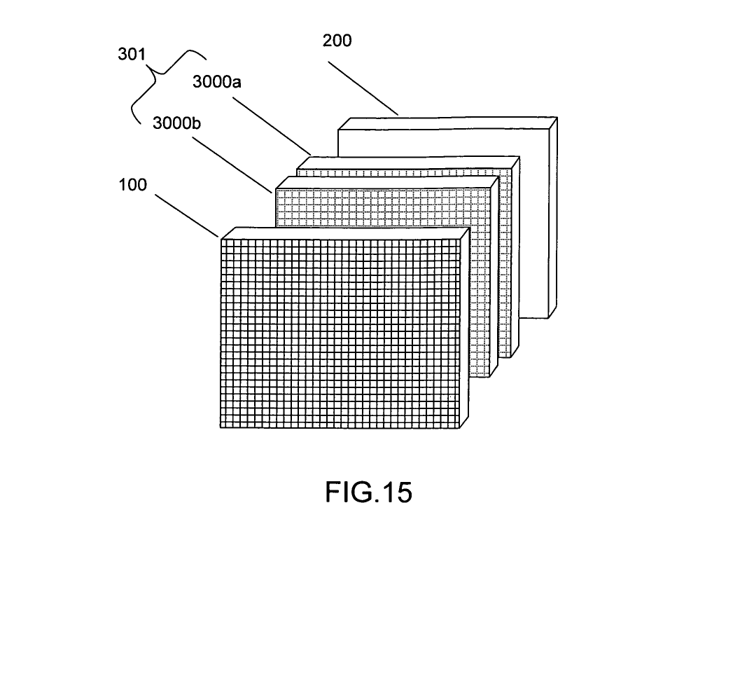

FIG. 14 is a schematic top view of a color autostereoscopic display similar in concept to that illustrated in FIG. 13. However, in the embodiment of FIG. 15 the SBG arrays are grouped in red green and blue pairs. The display comprises an illuminator 220, which provides red, green and blue illumination generally indicated by 11. A first group of arrays 2151a, 2151b each provide a light redirecting grid operative to deflect red light towards the right eye point 30b and the left eye point 30a. A second group of arrays 2152a, 2152b each provide a light redirecting grid operative to deflect green light towards the right eye point 30b and the left eye point 30a. A third group of arrays 2153a, 2153b each provide a light redirecting grid operative to deflect blue light towards the right eye point 30b and the left eye point 30a. In each case the light grid is provided by the columns of pixels of the array. For example, if we consider the propagation of blue light as illustrated in FIG. 14, the array 2153a directs the rays 1901a to 1905a towards the eye point 30a while the array 2153b directs the rays 1901b to 1905b towards the eye point 30b. In each case the light grid is provided by the columns of pixels of the array.

It will be clear from consideration of the embodiments described above that the light redirecting grids illustrated FIGS. 1-12 may be replaced by two dimensional arrays of electrically switchable diffractive elements. As shown in FIG. 15 the functional elements of such an autostereoscopic display comprise a SLM 100, a light source 200 and a light redirecting device 301. The function of the light redirecting device is to deflect light from the source 200 through the modulator towards the left and right eye positions. The light redirecting elements comprises a first light redirecting array 3000a and a second light redirecting array 3000b. Each said light redirecting array comprises a two dimensional array electrically switchable diffractive elements. The array are in optical contact with the SLM. Desirably, the first and second light redirecting elements have identical spatial frequencies.

It should be emphasized that FIGS. 1 to 14 are exemplary and that real autostereoscopic displays will have substantial greater numbers of pixels. It should further be emphasized that the dimensions of the display components and ray paths have been exaggerated. In a real display the viewing distance would be much larger and the pixel sizes would be much smaller. Typically, SLM pixel sizes would be tens of microns. In typical applications the display would be designed to provide an image size of around 15 inches diagonal with a viewing distance of 0.5 meter. Desirably, the SBG arrays and SLM would be laminated to provide a compact and lightweight device. Typically SBG layers will be several microns in thickness with substrate thickness ranging from fractions of a millimeter for small display to several millimeters in the case of large area displays.

Although the invention has been described in relation to what are presently considered to be the most practical and preferred embodiments, it is to be understood that the invention is not limited to the disclosed arrangements but rather is intended to cover various modifications and equivalent constructions included within the spirit and scope of the invention.

In the described embodiments the SLM and light redirecting grids are disposed such that the latter are located near to the input surface of a transmission SLM. However, it is possible to configure the display such that the light redirecting grids are located at the output surface of a transmission SLM.

In addition, although the invention has been described in relation to transmission SBGs and transmission SLMs, it will be clear to those skilled in the art of holographic optics and SLMs that the basic principles of the invention would applied in alternative embodiments using reflection holograms and reflection SLMs.

What is claimed is:

1. An autostereoscopic display comprising:
a light source [200,210,220]; and
a spatial light modulator [100,110,120] comprising a two dimensional array of electrically controllable light modulating pixels [112,113,114,121],
characterised in that there is further provided:
a first electrically switchable light redirecting grid [2000a, 2010a,2020a,2080a]; and
a second electrically switchable light redirecting grid [2000b,2010b,2020b,2080b],
wherein said spatial light modulator is in optical contact with said light redirecting grids,
wherein each said light redirecting grid comprises a plurality of elongate parallel switchable diffractive elements extending in a vertical direction,
wherein said light redirecting grids exhibit a diffracting state and a non-diffracting state,
wherein said first light redirecting grid is operative to diffract incident light through said spatial light modulator towards the left eye position [30a,32a] of a first viewing position when in said diffracting state,
wherein said second light redirecting grid is operative to diffract incident light towards the right eye position [30b,32b] of a first viewing position when in said diffracting state.
wherein said light directing grids are disposed between said source and said spatial light modulator.

2. The display device of claim 1, wherein said light redirecting grids are formed in separate layers.

3. The display device of claim 2, wherein each said light redirecting grid is one member of a first set of three light redirecting grids [2041a,2042a,2043a, 2051a,2052a,2053a] and wherein said second redirecting grid is one member of a second set of three redirecting grids [2041b,2042b,2043b, 2051b,2052b,2053b] each of said redirecting grids in each said set being holographically configured to deflect one of red green or blue color lights when in said diffractive state.

4. The display device of claim 2, wherein said light source is operative to sequentially illuminate said light redirecting grids with red light at a first incidence angle, green light at a second incidence angle and blue light at a third incidence angle.

5. The display device of claim 2, wherein each element of the said first and second light redirecting grids is operative to diffuse light into a multiplicity of directions towards a multiplicity of viewing positions.

6. The display device of claim 2, wherein said light source is operative to sequentially illuminate said light redirecting grids with red, green and blue light at substantially the same incidence angle

7. The display device of claim 2, further comprising a third light redirecting grid and a fourth redirecting grid [2020a,2020b,2030a,2030b], wherein said third and fourth light redirecting grid are operative to diffract light towards left [31a] and right [31b] eye positions respectively at a second viewing position.

8. The display device of claim 1, wherein first and second light redirecting grids are disposed in an interleaved fashion within a single layer [2060,2070,2100].

9. The display device of claim 8, wherein said interleaved first and second light redirecting grids are one of a set of three light redirecting grids [2110a, 2110b, 2110c] each of said light redirecting grids in each said set being holographically configured to deflect one of red, green or blue color lights when in said diffractive state.

10. The display device of claim 8, wherein said first and second light redirecting grids are switched sequentially.

11. The display device of claim 8, wherein said first and second light redirecting grids are switched simultaneously.

12. The display device of claim 8, wherein said light sources is operative to sequentially illuminate said light redirecting grids with red light at a first incidence angle, green light at a second incidence angle and blue light at a third incidence angle.

13. The display device of claim 8, wherein said light source is operative to sequentially illuminate said light redirecting grids with red, green and blue light at substantially the same incidence angle

14. The display device of claim 8, wherein each element of the said first and second light redirecting grids is operative to diffuse light towards a multiplicity of viewing positions.

15. The display device of claim 8, further comprising a third redirecting grid and a fourth redirecting grid, wherein said third and fourth light redirecting grids are operative to diffract light towards left and right eye positions respectively at a second viewing position.

16. The display device of claim 1, wherein said spatial light modulator comprises a two dimensional array of Switchable Bragg Grating pixels

17. The display device of claim 16, wherein said spatial light modulator and said light redirecting grids are combined in a single layer [2120]; wherein said first and second light redirecting grids are provided by alternating columns of Switchable Bragg Grating pixels.

18. The display device of claim 16, wherein said first and second light redirecting grids are switched sequentially.

19. The display device of claim 16, wherein said first and second light redirecting grids are switched simultaneously.

20. The display device of claim 16, wherein said light source is operative to sequentially illuminate said light redirecting grids with red light at a first incidence angle, green light at a second incidence angle and blue light at a third incidence angle.

21. The display device of claim 16, wherein each cell of the said first and second light redirecting grids is operative to diffuse light into a multiplicity of directions towards a multiplicity of viewing positions.

22. The display device of claim 16, further comprising a third light redirecting grid and a fourth light redirecting grid, wherein said third and fourth light redirecting grids are operative to diffract light towards left and right eye points respectively of a second viewing position.

23. The display device of claim 16, further comprising a second spatial light modulator; wherein said first redirecting grid is provided by the columns of said first spatial light modulator and said second redirecting grid is provided by the columns of said second spatial light modulator wherein said first and second spatial light modulators have identical spatial frequencies and are configured to overlap exactly.

24. The display device of claim 23, wherein said spatial light modulator is one member of a first set of three spatial light modulators [2141a,2142a,2143a, 2151a,2152a,2153a], and wherein said second spatial light modulator is one member of a second set of three spatial light modulators [2141b,2142b,2143b, 2151b,2152b,2153b], each of said spatial light modulators being configured to deflect one of red, green or blue color lights when in said diffractive state.

25. The display device of claim 1, wherein said light redirecting grids exhibit a diffracting state when no electric field is applied to a grid and a non-diffracting state when an electric field is applied to a grid.

26. The display device of claim 1, wherein said light redirecting grids are formed from electrically switchable Bragg gratings.

27. The display device of claim 1 wherein said spatial light modulator is an LCD.

28. The display device of claim 1 wherein said spatial light modulator is an electrically switchable diffractive device.

29. The display device of claim 1 wherein said spatial light modulator is a Holographic Polymer Dispersed Liquid Crystal Device.

30. The display device of claim 1 wherein said light redirecting grid bars and the columns of pixels of said spatial light modulator overlap exactly.

31. The display device of claim 1 wherein each column of spatial light modulator pixels overlaps more than one of said light redirecting grid bars.

32. The display device of claim 1 wherein each column of spatial light modulator pixels overlaps at least one of said first light redirecting grid bars and at least one of said second light redirecting grid bars.

33. The display device of claim 1 wherein left and right image perspective information is applied to odd and even columns respectively of the spatial light modulator.

34. The display device of claim 1 wherein left and right image perspective information is supplied time sequentially to the entire spatial light modulator array in phase with the switching of the first and second light redirecting grids.

35. The display device of claim 1 wherein said first electrically switchable light redirecting grid and said second electrically switchable light redirecting grid are provided by first and second two dimensional arrays [3000a,3000b] of electrically switchable diffractive elements, wherein each said elongate parallel switchable diffractive element comprises a column of two dimensional array elements.

36. The display device of claim 1 wherein said first electrically switchable light redirecting grid and said second electrically switchable light redirecting grid are provided by a two dimensional array of electrically switchable diffractive elements, wherein said elongate parallel switchable diffractive elements are provided by alternating columns of two dimensional array elements.

37. The display device of claim 1 wherein said SLM displays only the information for the left view point when the first light redirecting grid is in said diffracting state and the second light redirecting grid is in said non diffracting state, wherein said SLM displays only the information for the right eye viewpoint when the second light redirecting grid in said diffracting state and the first light redirecting grid is in said non diffracting state.

38. The display device of claim 1 wherein said first and second light redirecting grids are each in said diffracting state simultaneously and said SLM displays left and right eye point information in alternating columns.
